(19) United States
(12) Patent Application Publication
(10) Pub. No.: US 2009/0259598 A1
(43) Pub. Date: Oct. 15, 2009

(54) GRAPHICAL DISPLAY OF MARKET DEPTH IN AN ORDER BOOK

(76) Inventors: Dale M. John Stevens, Surrey (GB); Simon N. Douglas Deacon, London (GB)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/422,050

(22) Filed: Apr. 10, 2009

Related U.S. Application Data
(60) Provisional application No. 61/044,624, filed on Apr. 14, 2008.

(51) Int. Cl. G06Q 40/00; G06T 11/20

(52) U.S. Cl. 705/36 R; 345/440.2

(57) ABSTRACT

Consolidated order book and market depth information from multiple fragmented markets is presented on a display. The display provides a graphical representation of market depth and price points, balance, liquidity and volume-weighted average price for tradeable objects.

### CROSS-REFERENCE TO RELATED APPLICATIONS

This application claims priority to and the benefit of, and incorporates herein by reference, in its entirety, provisional U.S. patent application Ser. No. 61/044,624, filed Apr. 14, 2008.

### FIELD OF THE INVENTION

The invention relates generally to the graphical presentation of data, and more specifically to methods and supporting systems for presenting market and trading information in a manner that provides enhanced market knowledge and improves trading capabilities.

### BACKGROUND

Over the past few decades the trading of securities and other financial instruments has evolved from a primarily manual process to a collection of automated processes aided and facilitated by various technology platforms. As such, a trader can monitor and participate in markets and exchanges throughout the world and execute transactions in near real-time.

Using client devices such as personal computers, monitors and hand-held devices, (referred to collectively herein as “clients”) traders link to a host exchange through one or more networks (wired, wireless, etc.) to trade various investment products. To assist with identifying and executing trades in the market, traders utilize a variety of automated trading tools, that receive, display, and transmit orders for the various products to and from the exchange.

Because of the fast pace of many of these markets, market participants must be able to assimilate large amounts of data in order to quickly recognize market trends and to view current market conditions. Two aspects of the market that traders are constantly monitoring is the “market depth” for a particular equity and their order book. The market depth is a dimension of market liquidity reflecting a market's ability to absorb large trade volumes without a significant impact on price. A trader's order book a list of limit orders, prioritized by price and chronologically by time of entry that he wishes to fill by executing trades in the market. Matching a trader's order book to the market depth to understand how far into the market the trader must go to fulfill his book is one of the challenges of trading. Conventional means of displaying order book and market depth do not provide an integrated, complete view of the market in a manner that allows a trader to quickly and accurately gauge whether opportunities exist to exploit market conditions to the fullest extent.

### SUMMARY OF THE INVENTION

The invention provides methods and supporting systems for displaying a consolidated order book and associated market depth based on data received from multiple fragmented markets. The resulting display provides a graphical representation of market depth and price points, balance, liquidity and volume-weighted average price. Data for one or more tradeable objects is received from various exchanges and users can select from a listing of the objects. Once an object is selected, the user may also select one, more than one, or in some cases all the exchanges from which the data has been received. The data is then displayed in a consolidated grid that conveys the dynamics of the order book in a compelling and meaningful manner.

Therefore, in one embodiment, the invention provides a method for graphically displaying market depth in an order book for a tradeable object (e.g., a stock, option, bond, future, currency, warrant, fund, derivative, or commodity) that includes receiving market data corresponding to the tradeable object and graphically displaying an order book grid. The market data includes bid, offer and volume data from one or more electronic exchanges. The graphical representation of the received data includes a price differential axis indicating a price divergence range from a current price for the tradeable object, a volume axis indicating a range of units of the tradeable object available from the exchanges, and multiple order blocks (representing bids, offers, or in some cases both). The height of each order block is based on the number of units in the order book at a price differential from the current price for the tradeable object, and arranged in a step-wise fashion based on the price differential.

In some embodiments, the order blocks may be displayed in different colors, each color representing one of the exchanges providing the market data. The method may also include calculating a midpoint between a highest bid and lowest offer for the tradeable object and annotating the order book grid with a vertical line at the midpoint. In some cases, the method may further include calculating a volume-weighted average bid price at different volume levels for bids (and in some cases offers) in the order book and annotating the order book grid with a line indicating the volume-weighted average bid price for bids in the order book and/or volume-weighted average offer price for offers in the order book.

In some embodiments, an interactive control is provided to allow a user to adjust a price difference between axis labels of the price differential axis. In response to a user manipulating the control, the order book grid is adjusted accordingly.

In another aspect, the invention provides a system for graphically displaying market depth in an order book for a tradeable object. The system includes a data communications server for receiving market data (bid, offer and volume data) corresponding to the tradeable object from electronic exchanges and a processor for calculating order book data based on the received market data. The system also includes a display for graphically displaying the order book data as an order book grid. The order book grid includes a price differential axis indicating a price divergence range from a current price for the tradeable object, a volume axis indicating a range of units of the tradeable object available from the exchanges, and order blocks. The height of each order block is based on the number of units in the order book at a price differential from the current price for the tradeable object, and the order blocks are arranged in a step-wise fashion based on the price differential.

In another aspect, the invention provides an article of manufacture having a computer-readable medium with computer-readable instructions embodied thereon for performing the methods and implementing the systems described in the preceding paragraphs. In particular, the functionality of a method of the present invention may be embedded on a computer-readable medium, such as, but not limited to, a floppy disk, a hard disk, an optical disk, a magnetic tape, a PROM, an EPROM, CD-ROM, or DVD-ROM or downloaded from a server. The functionality of the techniques may be embedded on the computer-readable medium in any number of computer-readable instructions, or languages such as, for example, FORTRAN, PASCAL, C, C++, Java, C#, Tcl, BASIC and assembly language. Further, the computer-readable instructions may, for example, be written in a script, macro, or functionally embedded in commercially available software (such as, e.g., EXCEL or VISUAL BASIC).

Other aspects and advantages of the invention will become apparent from the following drawings, detailed description, and claims, all of which illustrate the principles of the invention, by way of example only.

### BRIEF DESCRIPTION OF THE FIGURES

In the drawings, like reference characters generally refer to the same parts throughout the different views. Also, the drawings are not necessarily to scale, emphasis instead is generally being placed upon illustrating the principles of the invention.

FIG. 1 is an illustration of an electronic trading system according to one embodiment of the invention.

FIG. 2 is an illustration of an electronic trading station to be used by a trader to participate in the market of FIG. 1.

FIG. 3 is an exemplary screen capture from a computer application that produces a graphical representation of an order book according to one embodiment of the invention.

### DETAILED DESCRIPTION

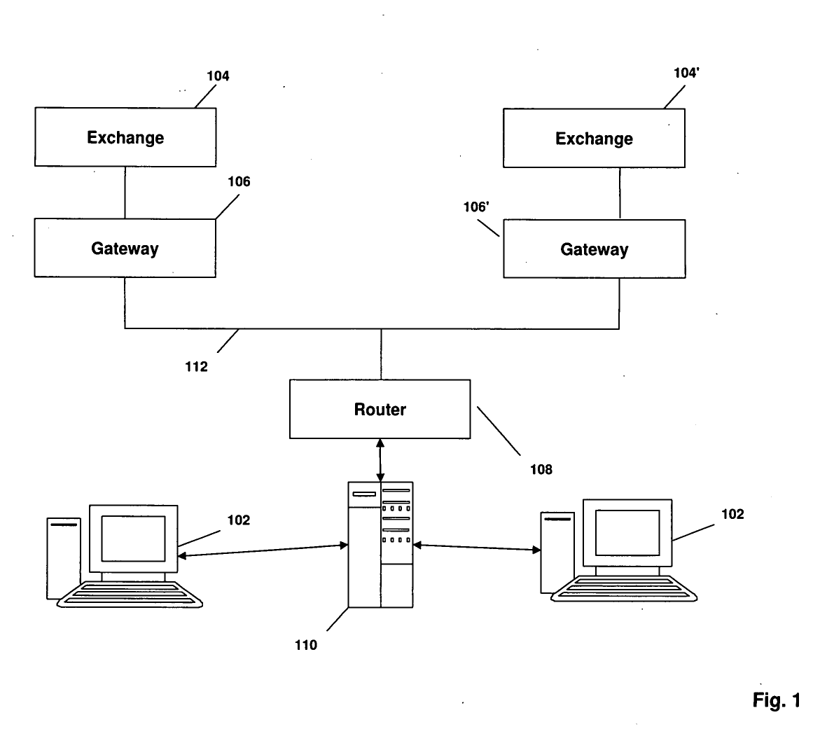

FIG. 1 illustrates an examplary electronic trading market in which the invention may be used to place, execute, and/or review trades. In this example, one embodiment of a trading system comprises a client device 102 that accesses one or more electronic exchanges 104 and 104′ (generally, 104) through respective exchange gateways 106 and 106′. As illustrated, the market includes two exchanges 104, but it should be understood that any number of exchanges 104 may participate in the market. A router 108 is used to route messages between a server 110 and the electronic exchanges 104. Typically, the electronic exchanges 104 include various computerized processes that match buy and sell orders sent from the client device 102 with orders from other client devices (not shown). The electronic exchanges 104 may list one or more tradeable objects for trading.

The computer employed as the client device 102 may be a hand-held device, laptop, or personal computer to a larger computer such as a workstation with multiple multiprocessors. Generally, the client device 102 includes a monitor (or any other output device) and an input device, such as a keyboard, a trackball, and/or a two or three-button mouse to support click based trading, if so desired. One skilled in the art of computer systems will understand that the present example embodiments are not limited to any particular class or model of computer employed for the client device 102 and will be able to select an appropriate system.

As used herein, the term “tradeable object” refers to anything that can be traded in some quantity for a particular price. For example, a tradeable object may be goods and/or financial products (e.g., stocks, options, bonds, futures, currency, and warrants, as well as funds, derivatives and collections thereof) and commodities, such as grains, energy, and metals. The tradeable object may be “real,” such as products that are listed by an exchange for trading, or “synthetic,” such as a combination of real products created by a trader or market participant. The market may be a traditional “open outcry” market or, in many instances, an electronic market such as the NASDAQ or Globex.

The server 110 may be a data communications server that includes one or more functional application modules that receive market data from the various electronic exchanges 104. The server may also include a processor (not shown) that provides the computational functionality for calculating the order book and market depth data described below. In some embodiments, the processing functionality may be distributed between the server 110 and the trading station 102. Some or all of this data may be stored in one or more databases, which may be centrally located on the server in some cases, or distributed among market participants in other cases.

In some embodiments, a live stream of data is received by the server 110 running an application as a server process under operating systems such as Linux, Sun Solaris, Microsoft Windows or a similar operating system. The server 110 receives live market data in real-time from one or more sources and the processor normalizes, combines and aggregates the data to produce the specific information that is displayed on the trading station 102. As information changes, the server 110 sends data updates to the trading station 102 via a TCP socket.

The electronic exchanges 104 provide market information via the server 110 to the client devices 102 that participate in the market. Market information may include commonly available trading data such as prices and volumes of bids and asks for various tradeable items. In some cases, the data may include so-called “inside market” data. The inside market is the lowest sell price (best ask) and the highest buy price (best bid) at a particular point in time. The market data may also include market depth. Market depth refers to quantities available at the inside market and may also refer to quantities available at other prices away from the inside market. The quantity available at a given price level is usually, although not necessarily, provided by the host exchange in aggregate sums. In other words, an exchange usually provides the total buy quantity and the total sell quantity available in the market at a particular price level in its data feed. The extent of the market depth available to a trader usually depends on the exchange. For instance, some exchanges provide market depth for all (or most) price levels, while some provide only quantities associated with the inside market, and others may provide no market depth at all. Additionally, the exchanges 104 may offer other types of market information such as the last traded price (LTP), the last traded quantity (LTQ), and order fill information.

The actual electronic trading system configurations are numerous, and a person skilled in the art of electronic trading systems would be able to construct a suitable network configuration. In one embodiment, the gateway device may be located at the client site along with the trading station, which is usually remote from the matching process at the electronic exchange. According to this instance, the trading station, the gateway, and the router may communicate over a local area network 112, and the router may communicate with the matching process at the electronic exchange over a T1, T3, ISDN, or some other high speed connection.

In another example illustration, the client site may be located on the actual grounds of the electronic exchange (for example, in the building of the exchange). According to this instance, the trading station, the gateway, and the router may still communicate over a local area network, but the router may communicate with the matching process at the electronic exchange through another connection means besides a T1, T3, or ISDN. In yet another example illustration, the gateway may be housed at, or near, its corresponding electronic exchange. According to this instance, the client device may communicate with the gateway over a wide area network 112 or through the use of a T1, T3, ISDN, or some other high speed connection.

Further, the gateway may be located remote from the client device 102 and remote from the electronic exchanges 104, which might be particularly useful in systems that include interconnection of multiple trading networks. Thus, one trading network might have gateway access to a primary electronic exchange and other trading networks utilize the first network to access the exchange.

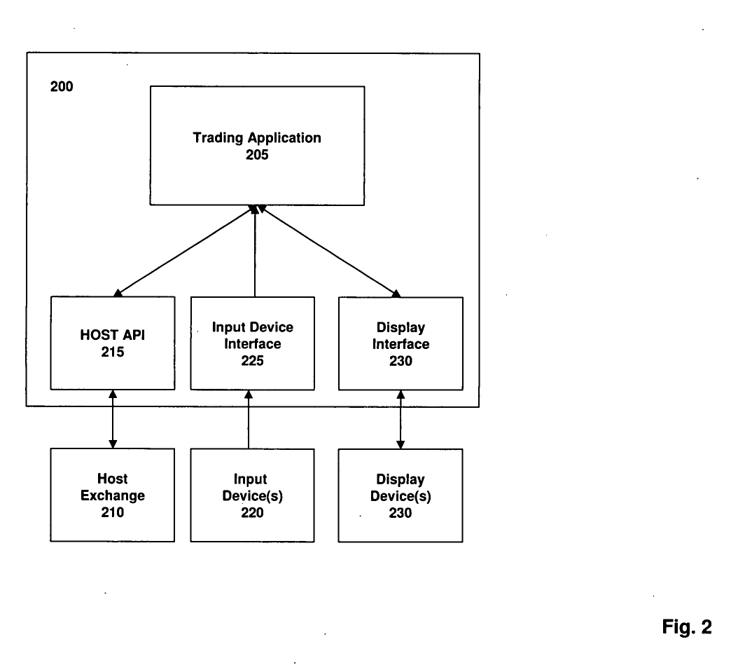

FIG. 2 illustrates an example trading station 200 which may be used as a the client device 102 as shown in FIG. 1. Trading station 200 can be any particular type of computing device, examples of which were enumerated above. According to one example embodiment, a trading application 205 is stored in memory of the trading station 200, and when executed arranges and displays market information in many particular ways, usually depending on how the trader prefers to view the information.

Preferably, trading application 205 has access to market information from one or more exchanges 210 through APIs 215 (application programming interfaces), and the trading application 205 may also forward transaction information to the exchanges 210 via APIs 215. Alternatively, the APIs 215 may be distributed so that a portion of the API rests on the trading station 200, a portion resides on the sever, routers gateways, and/or at the exchanges 210. Additionally, trading application 205 may receive signals from input device 220 via input device interface 225 and can be given the ability to send signals to display device 230 via display device interface 235. The trading application 205 provides the programming logic to receive and process market information and present the information as a market-depth order grid as described below.

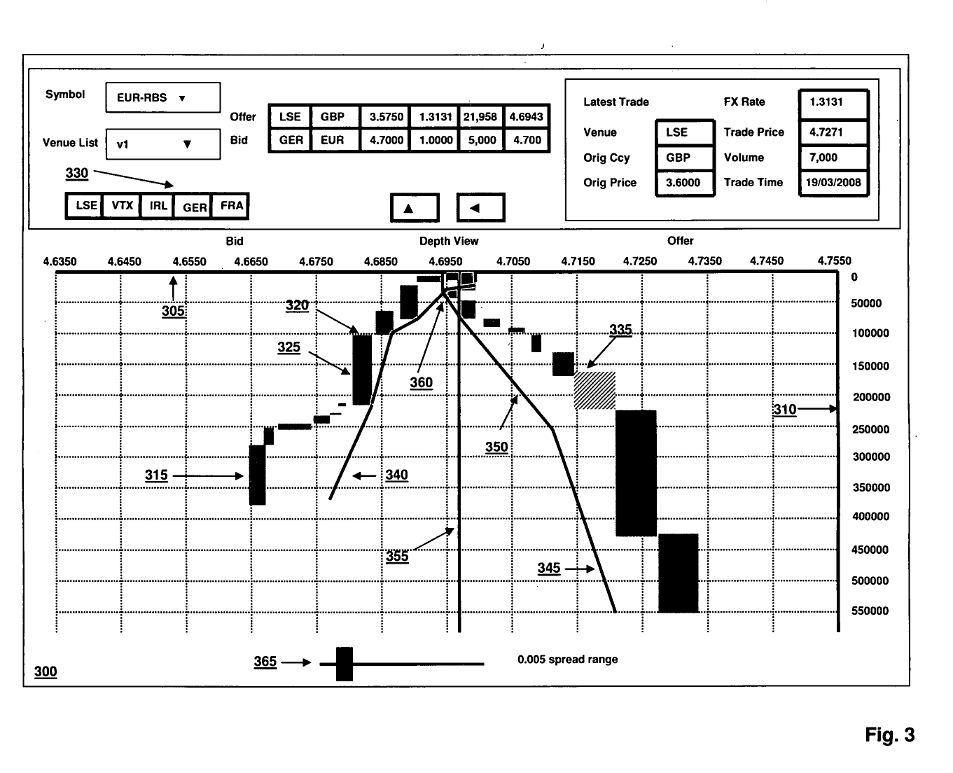

Referring to FIG. 3, the components of a market-depth order book grid 300 according to one embodiment of the invention is illustrated. The order book represents all outstanding orders to buy or sell a tradeable object within a market.

In one embodiment, the aggregated market depth grid 300 includes a scaled price axis (x-axis) 305 and a volume axis (y-axis) 310 against which outstanding bids and offers are plotted as they are entered by traders. The minimum, maximum, and scale of the axes may change depending on the price of the tradeable object and the number of shares currently being offered or bid. In some embodiments, the scales, maximums, minimums and/or the segmentation of the axes is automatically determined, whereas in other cases one or more of the axis parameters may be manually set and adjusted.

Order blocks 315 represent a collection of orders (bids, shown on the left of the grid, and offers shown on the right) for the tradeable object, grouped according to the bid or offer price. The order blocks 315 are visually represented using an x-axis component 320 and y-axis component 325, which together define the height and width of the order block 315 as presented on the grid 300. For offers, the x-axis component 320 represents the next incremental cost above the previously higher price that a trader will have to pay to obtain the tradeable object, and defines the upper-right corner of the block 315. The y-axis component 325 represents the volume of shares (or other units) offered in the market at that price, and therefore the order block 315 extends down accordingly.

Similarly, for bids, the x-axis component 320 represents the incremental price below the previously lower price that market participants are prepared to pay for the tradeable object, and therefore defines the upper-left corner of the block 315. The y-axis component 325 represents the volume of shares (or other units) available at that price, and therefore the order block 315 extends down accordingly. As such, the blocks 315 are arranged in a step-wise fashion downward to represent the depth of the market—the deeper the stack of order blocks, the deeper the market.

In some embodiments, market data may be received from multiple exchanges 330, in which case the order blocks 315 may be color-coded accordingly. For example, blocks 315 of tradeable objects from the German Exchange may be colored green, and match the color scheme of the market indicator 330 for that market. Traders may select (or de-select) one or more markets 330 for display, and thus obtain valuable information about which exchanges have active markets for the tradeable object.

Access to the detailed market data further facilitates the calculation of a volume-weighted average price (VWAP) on both the bid 340 and offer 345 sides of the market, as well as a volume-weighted average spread (VWAS). The VWAP indicates, at each volume level, the average price one must pay (for offers) or accept (for bids) down to a particular number of units. For example, if a buyer in the market wanted to purchase 200,000 shares of RBS, he would pay an average price of 4.710 per share, as indicated by the point at which the VWAP intersects the 20,000 volume line 350. The VWAS is the price spread of the bid and offer VWAP points down in to the order book, such that the bid VWAP line 340 and the offer VWAP 345 line together create a VWAS line pair at each trading volume point though the entirety of the market. A mid-price line 355 indicates the mid-point between the best bid price and best offer price of the market. In some cases where the order books are aggregated from multiple markets, the bid VWAP line 340 and offer VWAP line 345 may cross at an intersection point 360 that does not coincide with the mid-price line 355, indicating an imbalance across markets and a potential arbitrage opportunity for the trader.

In some embodiments an interactive control 365 may be provided (as a sliding bar, combo-box, radio dial, or other control) that allows a trader to alter the scale of the x-axis. Adjusting the granularity of the grid 300 causes the width of the order blocks 315 to change accordingly, and permits the user to “zoom-in” if the changes in price from block to block cannot be detected with the current scale.

In one embodiment, the display is rendered using Microsoft Windows Presentation Foundation (WPF) technology on the screen of the trading station or other device running the Microsoft Vista operating system. In such an implementation, a user may select certain data to be displayed, which in turn updates the display as new data is received from the server 110. While the current implementation of the display object was done using Microsoft WPF technology, it may also be implemented with a variety of technologies including (but not limited to): Adobe Flash, Apple OpenGL and Apple Core Image.

The application components described throughout the specification can be implemented in whole or in part as a software program using any suitable programming language or languages (C++, C#, java, LISP, BASIC, PERL, Flash, etc.) and/or as a hardware device (e.g., ASIC, FPGA, processor, memory, storage and the like).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A computer-implemented method for graphically displaying market depth in an order book for a tradeable object, the method comprising:
(i) receiving market data corresponding to the tradeable object, the market data comprising bid, offer and volume data from a plurality of electronic exchanges; and
(ii) graphically displaying an order book grid, the grid comprising:
(a) a price differential axis indicating a price divergence range from a current price for the tradeable object;
(b) a volume axis indicating a range of units of the tradeable object available from the exchanges; and
(c) a plurality of order blocks, wherein the height of each order block is based on the number of units in the order book at a price differential from the current price for the tradeable object, and arranged in a step-wise fashion based on the price differential.

2. The method of claim 1 wherein the plurality of order blocks represent bids in the order book.

3. The method of claim 1 wherein the plurality of order blocks represent offers in the order book.

4. The method of claim 1 further comprising displaying each of the plurality of order blocks in one of a plurality of colors, each color representing one of the plurality of exchanges.

5. The method of claim 1 further comprising
(i) calculating a midpoint between a highest bid and lowest offer for the tradeable object; and
(ii) annotating the order book grid with a vertical line at the midpoint.

6. The method of claim 1 further comprising:
(i) calculating a volume-weighted average bid price at a plurality of volume levels for bids in the order book; and
(ii) annotating the order book grid with a line indicating the volume-weighted average bid price for bids in the order book.

7. The method of claim 1 further comprising:
(i) calculating a volume-weighted average offer price at a plurality of volume levels for offers in the order book;
(ii) annotating the order book grid with a line indicating the volume-weighted average offer price for offers in the order book.

8. The method of claim 1 further comprising:
(i) providing an interactive control for adjusting a price difference between axis labels of the price differential axis;
(ii) receiving instructions from a user via the interactive control to adjust the price difference between axis labels of the price differential axis; and
(iii) redisplaying the order book grid based on the received instructions.

9. The method of claim 1 wherein the tradeable object is one of a stock, option, bond, future, currency, warrant, fund, derivative, commodity or other tradeable financial instrument.

10. A system for graphically displaying market depth in an order book for a tradeable object, the system comprising:
(i) a data communications server for receiving market data corresponding to the tradeable object, the market data comprising bid, offer and volume data from a plurality of electronic exchanges;
(ii) a processor for calculating order book data based on the received market data; and
(iii) a display for graphically displaying the order book data as an order book grid, the grid comprising:
(a) a price differential axis indicating a price divergence range from a current price for the tradeable object;
(b) a volume axis indicating a range of units of the tradeable object available from the exchanges; and
(c) a plurality of order blocks, wherein the height of each order block is based on the number of units in the order book at a price differential from the current price for the tradeable object, and arranged in a step-wise fashion based on the price differential.
